(19) United States
(12) Patent Application Publication
(10) Pub. No.: US 2013/0085871 A1
(43) Pub. Date: Apr. 4, 2013

(54) BROWSER BASED COMPOSITION INTERFACE FOR TAGS LINKABLE BY WEBPAGES

(71) Applicants: Brian William Goss, Cambridge, MA (US); Nicholas Alexander Rutherford, Cambridge, MA (US)

(72) Inventors: Brian William Goss, Cambridge, MA (US); Nicholas Alexander Rutherford, Cambridge, MA (US)

(73) Assignee: Local.Com Corporation, Irvine, CA (US)

(21) Appl. No.: 13/250,313

(22) Filed: Sep. 30, 2011

(51) Int. Cl. G06Q 30/02; G06F 3/01

(52) U.S. Cl. 705/14.73; 715/760

(57) ABSTRACT

A method and system of creating interactive content to be linked via a tab to appear in a web page is disclosed. A first panel including a first object displayable on the web page is provided via a composer interface. The first object has a first interaction when displayed on the web page. A second panel including a second object is provided via the composer interface. The second object is displayable on the webpage in place of the first panel. A timeline is created via the composer interface to sequentially present the first and second panels in the web page. The ad is made available for display in the web page via the tab when the web page is requested by a user device.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present invention relates generally to a browser based interface to produce tags for content websites, and more particularly, to a browser interface allowing a user to produce a tag web object for insertion in a content webpage.

### BACKGROUND

The Internet has provided a new advertising opportunity to reach different users. Content providers on the Internet have sought to use advertising embedded in content web pages to provide a source of revenue. Advertisers are linked to content sites and seek to provide the best exposure to their ads in the content sites. Various ads must be tailored specifically to websites, which is a time consuming process since each ad must be fit into a particular website. In order to expedite the display of such advertising, the content website often provides a link or a tag to call particular advertising content. When activated, the link will access additional material to be sent to the requesting browser such that the ad may dynamically behave to draw a user's attention.

A dimension of webpage advertising is the use of interactive or dynamic ads that may activate video or audio clips to draw attention to the advertising. Such advertising is more memorable to a viewer but often requires specialized software such as Flash to develop the animation presented to a viewer of a content web page. Additional software such as Photoshop may be required to further refine graphics. Development of such advertising requires programming resources to insure that the proper effects are delivered to a content web page to effectively present the multi-media content.

Thus, there is a need for an accessible composer interface to create and provide tags for advertising material using multi-media features to content web pages. There is a further need for an interface that may provide tracking of user data for advertising. There is also a need for an interface that may convert created tagged advertising content into a common file format for loading on content web pages via a code link.

### SUMMARY

According to one example, a method of creating interactive content to be linked via a tag to appear in a web page is disclosed. A first panel including a first object displayable on the web page is provided via a composer interface. The first object has a first interaction when displayed on the web page. A second panel including a second object is provided via the composer interface. The second object is displayable on the webpage in place of the first panel. A timeline is created via the composer interface to sequentially present the first and second panels in the web page. The tag is made available in the web page for displaying the first and second panels when the web page is requested by a user device.

Another example disclosed is a system for distributing advertising web based ads to content web page providers. The system includes a composer interface to provide an ad for display on a web page. The ad causes a sequential display of media objects based on at least a first panel and a second panel. An advertising storage server stores the ad generated by the web based composer interface. A tab allows access to the advertising storage server for the ad; the tab is insertable in the web page.

Another example is a browser based interface for creating content linked via a tag to a web page. The interface includes a workspace field for placement of objects representing the content for linking from the web page. A media content storage interface allows selection of a media content object for the workspace field. A panel control displays one of a plurality of panels in the workspace field. The panel control includes a timeline control to sequence the appearance of objects in the panel. An object control menu determines the appearance of at least one object placed in the workspace field.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a system that may be used to generate website advertising content and make it available for multiple browsing devices;

FIG. 2A is a management interface screen for controlling and creating campaigns, tags, and ads;

FIG. 2B is a summary screen of current campaigns generated from the interface in FIG. 2A;

FIG. 2C is a window for the creation of a new campaign based on the interface in FIG. 2A;

FIG. 2D is a campaign input screen that allows a user to set the parameters of a new ad;

FIG. 3 is a main composer screen from a selection from FIG. 2 of a specific tab web page;

FIG. 4A is the asset access screen that allows the selection of different content files for the composer interface in FIG. 1;

FIG. 4B is the object control window of the composer interface in FIG. 3 for a selected text object;

FIG. 4C is the object control window of the composer interface in FIG. 3 for a selected drawing object;

FIG. 4D is the object control window of the composer interface in FIG. 3 for a selected video object;

FIG. 4E is the object control window of the composer interface in FIG. 3 for a selected animation object;

FIG. 4F is the object control window of the composer interface in FIG. 3 for a selected panel;

FIG. 4G is the interactions tab of the object control window of the composer interface for a selected object;

FIG. 4H is the interactions tab of the object control window of the composer interface for a selected object;

FIG. 5A-5C are screen images of the resulting previews from selecting the preview button in the composer interface in FIG. 3;

FIG. 6A is a screen image of the management interface showing the controls to deploy completed ads and tags;

FIG. 6B is a screen image of the publishing selection from the control interface in FIG. 2;

FIG. 6C is a screen image of the demo selection from the control interface in FIG. 2;

FIG. 6D is a screen image of the reports selection from the control interface in FIG. 2;

FIGS. 7A-7F are a sequence of screen images of assembling an interactive ad using the composer interface of FIG. 3;

FIG. 8 is a block diagram of a computing device in the system in FIG. 1; and

FIG. 9 is a flow diagram of the process of creating a tag for linking an ad to a content webpage.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

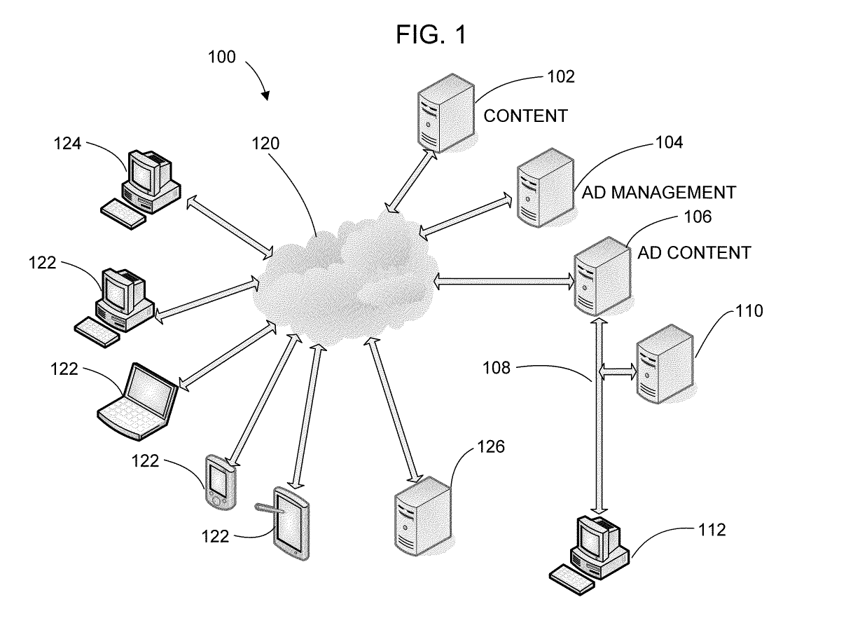

FIG. 1 shows a network system 100 that may include a content server 102 that belongs to a content provider for providing content in the form of content web pages. An advertising server 104 belongs to an advertising agency that provides web based ads to the content provider for insertion in the content web pages. In this example, an advertising content provider has an advertising content server 106 that stores tags or web page components that may be directed by the advertising server 104 to content providers with web pages such as those provided by the content server 102. In this example, the content web pages are primarily content, but contain areas of the page controlled by a tag or tags for display of advertising that is managed by the advertising server 104. The advertising agency therefore serves as an agent to sell advertising in areas of the content web page provided by the content server 102. The tags are the lines of code that are provided (usually copied/pasted) to advertising servers such as the advertising server 104 to serve to the content web page when appropriate. Tags call code from the advertising content server such as the advertising content server 106 that add the ad to the web page. There could be multiple, and separate, visible elements of an ad added to the web page by the code in a tag.

In this example, the advertising content server 106 serves as a gateway for a private network 108. The private network 108 includes a media storage server 110 and a series of workstations such as a workstation 112. The workstation 112 is web enabled via software such as a web browser program and allows users to generate advertising tags or content for loading on the advertising content server 106 and for provision to content web pages in areas for advertising content. It is to be understood that the servers 102, 104, 106, and 110 may be hardware or software or may represent a system with multiple servers, which may include internal networks. In this example the servers 102, 104, 106, and 110 may be hardware server devices, although other types of servers may be used. Further, additional servers and workstations and other devices may be coupled to the system 100 or the private local area network 108 and many different types of applications may be available on servers coupled to the system 100. Each of the network nodes, such as application servers 106 and 110 and workstations such as the workstation 112 include a network interface such as a network interface card for establishing a communication channel to another network node.

A content provider or publisher may have a server such as the content server 102 that serves requested content web pages over a wide area network such as the Internet 120 to requesting user devices 122. In this example, the content provider or publisher contracts with an advertising producer to insert advertising into the content web pages provided by the content server 102. The provided content web pages include built in tag code to access content such as ads provided by the advertising content server 106 and managed by the advertising server 104. In this example, the advertising tags that are delivered for a particular content web page may be based on a decision engine in the advertising server 104 that determines what ad to deliver and line of code to communicate with the content server 102.

The private network 108 may provide a connection to a wide area network (WAN) such as the Internet 120 via one of the application servers such as the advertising content server 106. In this example, the content server 102 may communicate with the advertising server 104 and the advertising content server 106 via the Internet 120. Various web enabled devices such as the user devices 122 are coupled to the wide area network 120 and may access the content in servers that provide content in response to public requests such as the content server 102. Outside workstations such as a computing device 124 may be provided access to various servers such as the advertising content server 106 or the media content server 110 in the private network 108 with the proper security credentials.

The user devices 122 may include virtually any computing device that is configured to send and receive information over a network, such as the network 120. In this example, the user devices 122 are web enabled and may run browser software for the presentation of web pages to the user. Such user devices 122 may include conventional personal computers (PCs), portable devices such as cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. The user devices 122 implemented as personal computers may include multiprocessor systems, microprocessor-based or programmable consumer electronics, desktop or laptop computers, network PCs, and the like. As such, user devices may range widely in terms of capabilities and features.

As exampled above, the web-enabled user devices 122 may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information.

The user devices 122 may also include at least one client application that is configured to receive control data and/or content from another computing device via a network transmission. The client application may include a capability to provide and receive textual content, graphical content, video content, audio content, and the like. Moreover, the user devices 122 may be further configured to communicate and/or receive a message, such as through a Short Message Service (SMS), direct messaging (e.g., Twitter), e-mail, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between or with another computing device, and the like.

The private local area network 108 may include one or more additional intermediary and/or network infrastructure devices in communication with each other via one or more wired and/or wireless network links, such as switches, routers, modems, or gateways (not shown), and the like, as well as other types of network devices including network storage devices. A proxy server may also be employed by the local area network 108. From the perspective of the users of the wide area network 120 such as the users of computing device 124, they have directly established a connection in the usual way to the appropriate servers 106 and 110 and respective server applications. The existence of a proxy connection may be entirely transparent to a requesting client computer. The implementation of such a proxy may be performed with known address spoofing techniques to assure transparency, although other methods could be used. Communications between the network nodes on the private local area network 108 may be conducted via the Ethernet standard in this example. Further outside media content sources such as a media content source server 126 may be accessed by users within the private local area network 108 via the Internet 120 or by users connected to the Internet 120 directly such as the computing device 124.

The networks 108 and 120 are configured to couple one computing device with another computing device. The networks 108 and 120 may be enabled to employ any form of computer readable media for communicating information from one electronic device to another. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines; full or fractional dedicated digital lines including T1, T2, T3, and T4; Integrated Services Digital Networks (ISDNs); Digital Subscriber Lines (DSLs); wireless links including satellite links; or other communication links known to those of ordinary skill in the art. Furthermore, remote computers and other related electronic devices can be remotely connected to either LANs or WANs via a modem and temporary telephone link.

The networks 108 and 120 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. The networks 108 and 120 may also include an autonomous system of terminals, gateways, routers, and the like connected by wireless radio links or wireless transceivers. These connectors may be configured to move freely and randomly and organize themselves arbitrarily, such that the topology of the networks 108 and 120 may change rapidly and arbitrarily.

The networks 108 and 120 may further employ a plurality of access technologies including 2nd (2G), 2.5, 3rd (3G), 4th (4G) generation radio access for cellular systems; WLAN; Wireless Router (WR) mesh; and the like. Access technologies such as 2G, 3G, 4G, and future access networks may enable wide area coverage for mobile devices, such as one or more of user devices 122, with various degrees of mobility. For example, the networks 108 and 120 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. The networks 108 and 120 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, the networks 108 and 120 may include virtually any wired and/or wireless communication mechanisms by which information may travel between one computing device and another computing device, network, and the like.

The media content sources such as the server 126 or the server 110 may include any of a variety of providers of network transportable digital content, some of which may be RSS (Really Simple Syndication) feeds, denoted generally as content or content items. The network transportable digital content can be transported in any of a family of file formats and associated mechanisms usable to enable a host site and a user platform such as the workstation 112 to receive media content from a media content source over a network such as the LAN 108 or the Internet 120. In one example, the file format can be Flash, however, the various embodiments are not so limited, and other file formats and transport protocols may be used. For example, media content formats other than Flash or formats other than open/standard feed formats can be supported by various applications. Any electronic file format, such as Portable Document Format (PDF), XML, audio (e.g., Motion Picture Experts Group Audio Layer 3-MP3, and the like), video (e.g., MP4, and the like), and any proprietary interchange format defined by specific content sites can be supported by the various embodiments described herein. Furthermore, although RSS content can be used, the various embodiments are not limited to RSS. For example, Atom, a syndication specification adopted by the Internet Engineering Task Force (IETF) may also be employed. As used throughout this application, including the claims, RSS refers to RSS, Atom, and other syndication file formats derived therefrom. Moreover, a particular content source such as the media server 126 or 110 may provide more than one media content item or media content feed.

Referring now to the example in FIG. 1, the system 100 allows networked computer users such as those on dedicated workstations such as the workstation 112 or outside computers such as the computing device 124 to create and manage content such as advertising content for a web page that has dynamic scripting incorporating designated content objects. In various example embodiments, an application or service, typically operating on a host site (e.g., a website) that is provided by a web server, is provided to simplify and facilitate web domain generation and management for a user at a user platform such as the workstation 112. The media content server 110 provides a plurality of media content items (e.g., documents, text, images, video/audio clips, graphics, animations, executable code, widgets, etc.) for inclusion in the web page. One or more of the media content sources may be provided by one or more content publishers or content aggregators operating at various locations in a network ecosystem and connected to the wide area network 120. It will be apparent to those of ordinary skill in the art that media content sources may be any of a variety of networked content providers or content aggregators.

In one example, a user workstation platform such as the web-enabled computing device 124 or the workstation 112 within the private network 108 enables a user to create and manage tags or content for links from content web pages. The tags in this example are advertising based with multi-media content created using a web browser composer interface. Such tags may include multi-media content from the content sources such as the content server 110. The techniques described herein may be used for other applications other than advertising for management of tags with media content.

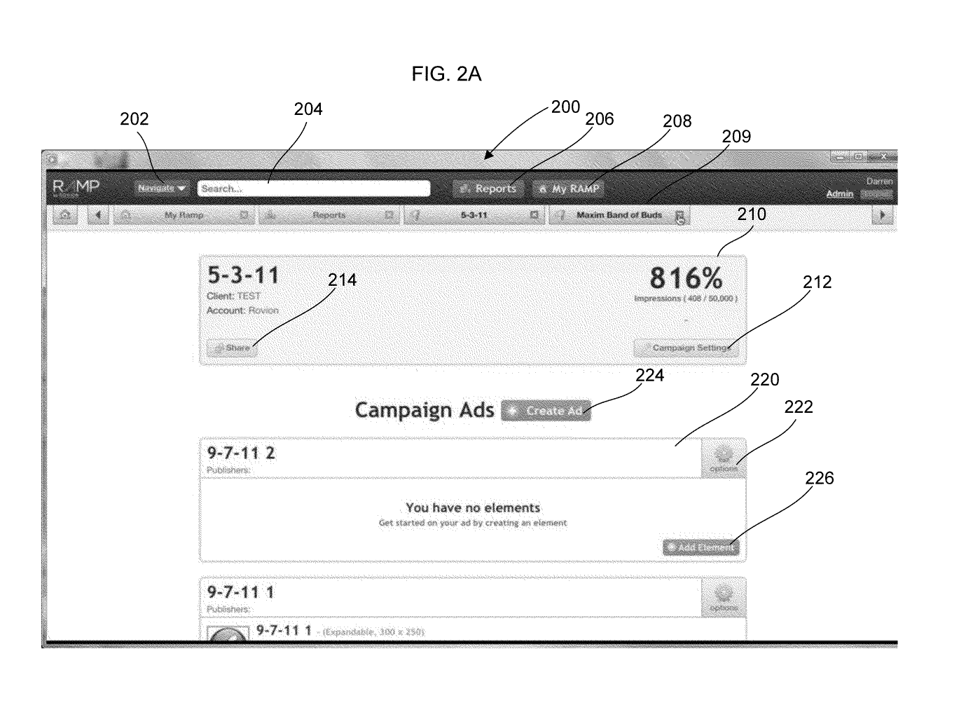

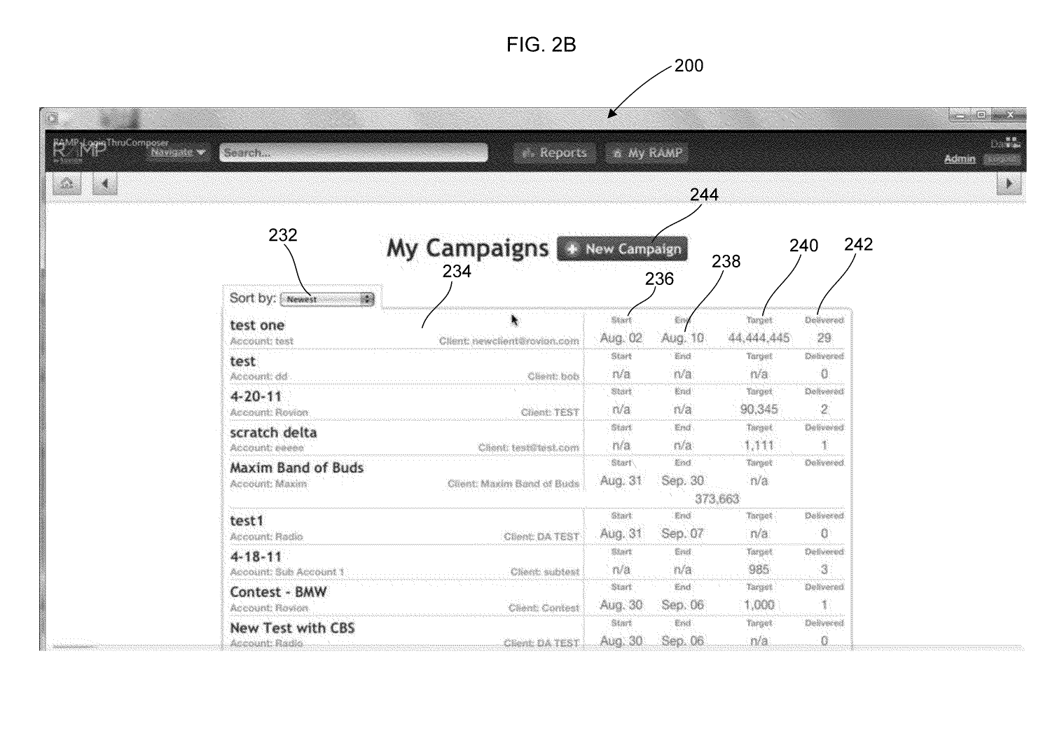

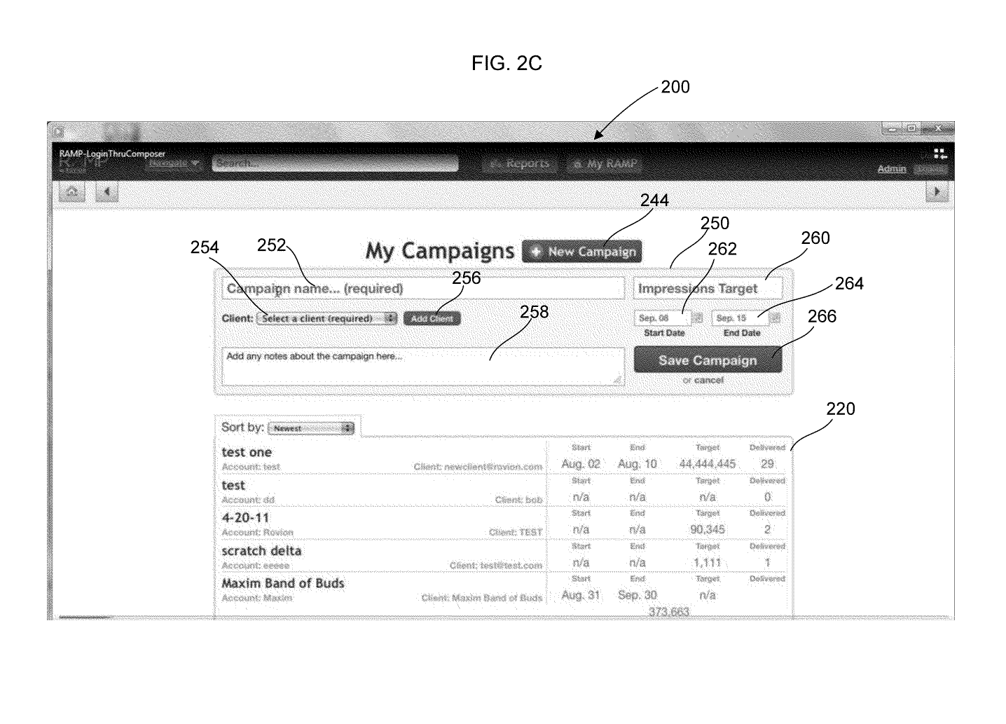

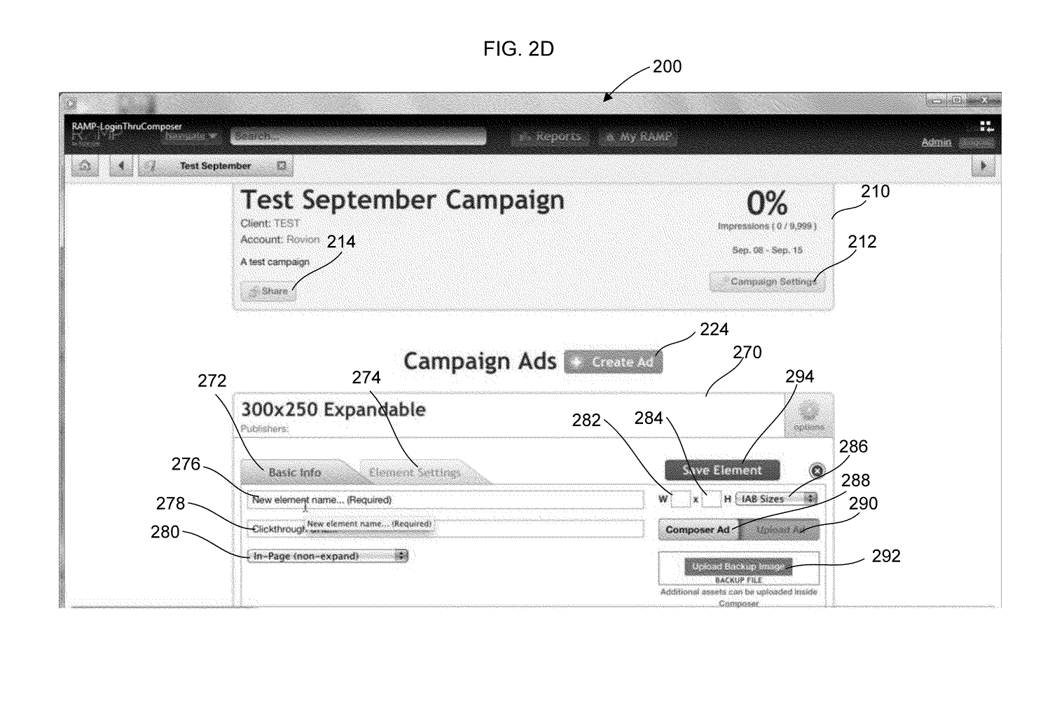

FIG. 2A is a screen image showing a browser based campaign management interface 200 that may be displayed on a web enabled workstation such as the workstation 112 or the computing device 124. The campaign management interface 200 is accessed to manage the example advertising tags or content that may be inserted into web pages published by content providers via the content server 102 in conjunction with the advertising server 104. Of course other types of content may be provided other than advertising web pages. The browser based management interface 200 in this example allows a user to manage individual advertising content or tags that are integrated with content provided by a content provider on an overall web page. In this example, the ads are part of a tag that is associated with a particular content web page such as that offered by the content server 102 in FIG. 1. The tags are organized by a campaign, which in this example may be grouped by a particular time period and or geographical region. The campaigns may be associated with a client offering the advertising. The clients may be associated with a particular account. Of course other forms of organization may be used to catalog and access the produced advertising tags or content.

The campaign management interface 200 may include a standard menu bar that includes a navigate button 202 and a search field 204. The navigate button 202 and search field 204 may be employed to access tag content that may be stored in the advertising content server 106 in FIG. 1. The navigate button 202 allows navigation to ads by client name campaigns and ads. The search field 204 allows search by entering search terms. The menu bar also includes navigation devices such as a home icon to return to the interface 200. The interface 200 includes a reports button 206 and a campaign access button 208 to allow the user to set the access level for other users to various campaigns.

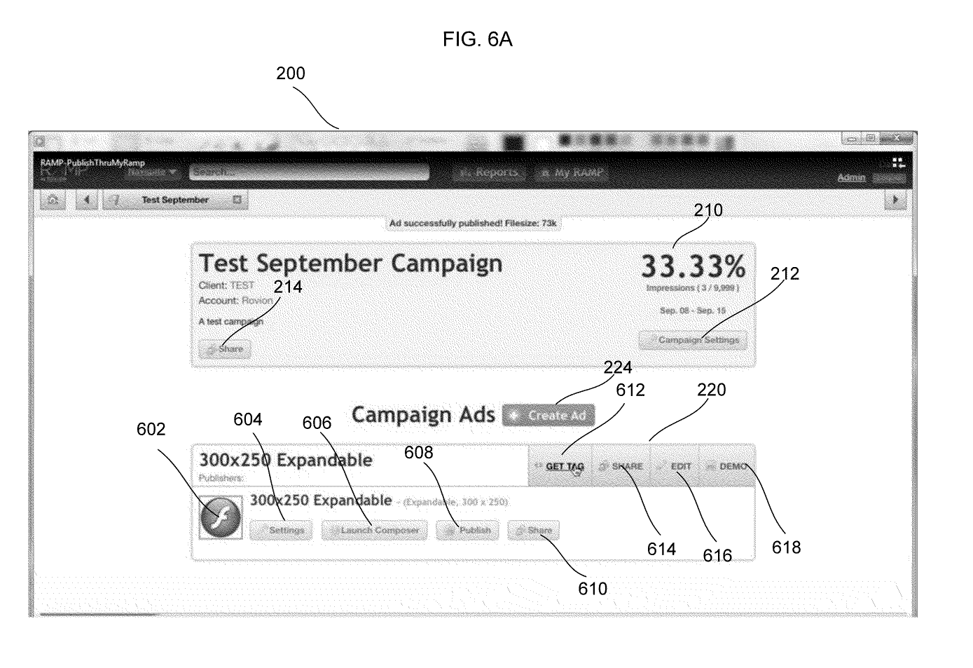

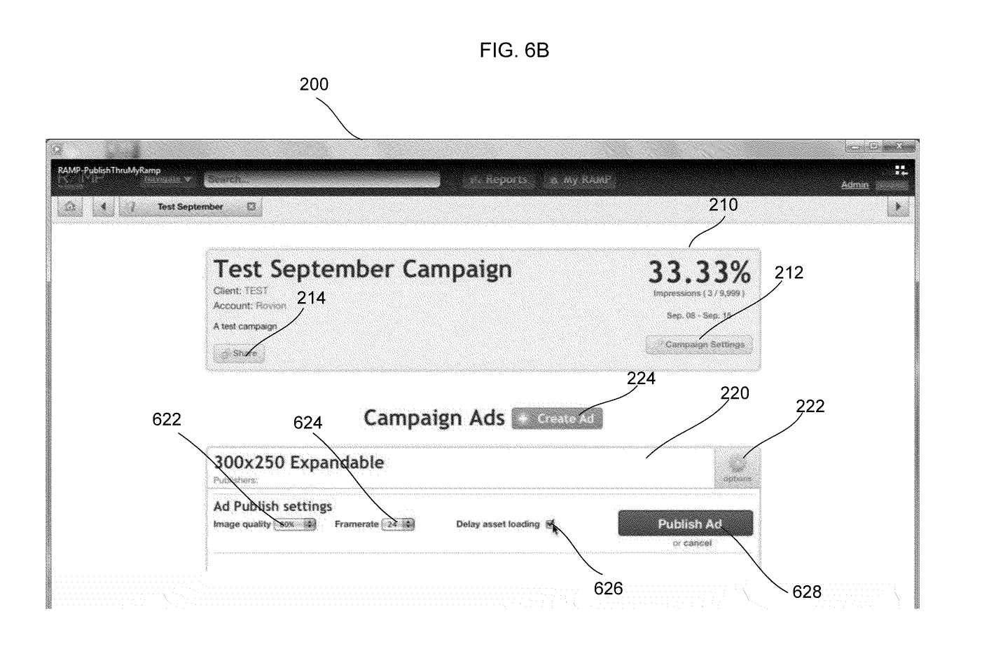

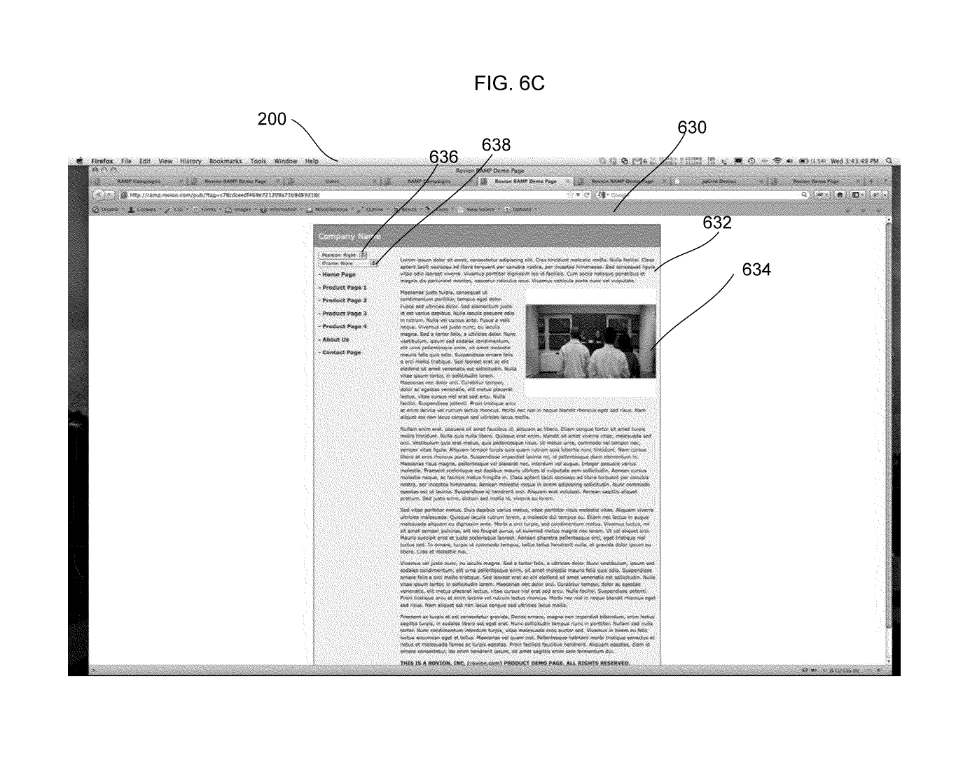

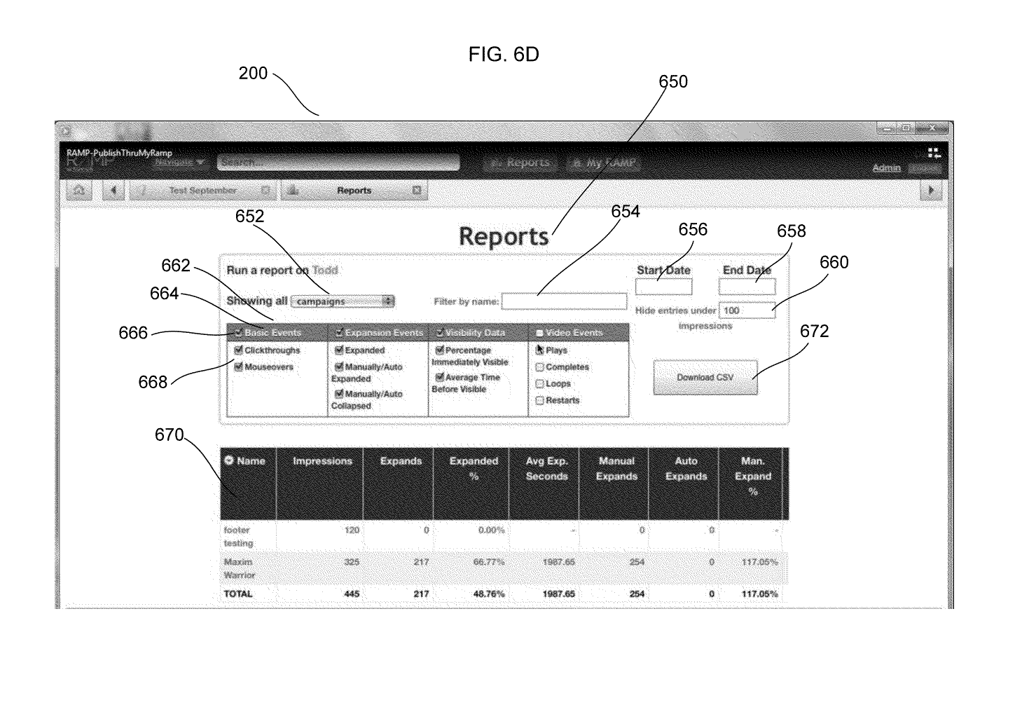

A number of the campaigns tabs 209 may be selected and allows the user to display summary information by specific campaign on the interface 200. As will be explained below with reference to FIG. 6D, the reports button 206 enables a user to determine statistics on access to advertising content on the advertising content server 106 based on statistics collected by the advertising server 104 in FIG. 1. In this example, a specific campaign has been selected and thus, the interface 200 shows a campaign summary window 210 that includes summary information on each campaign such as the client, the account, an impressions summary statistics area, and a campaign settings button 212.

The campaign settings button 212 allows the user to modify campaign information as will be explained below. A share button 214 allows a user to share the campaign to a user or users on the network such as the local network 108 in FIG. 1 by entering network identification such as an e-mail.

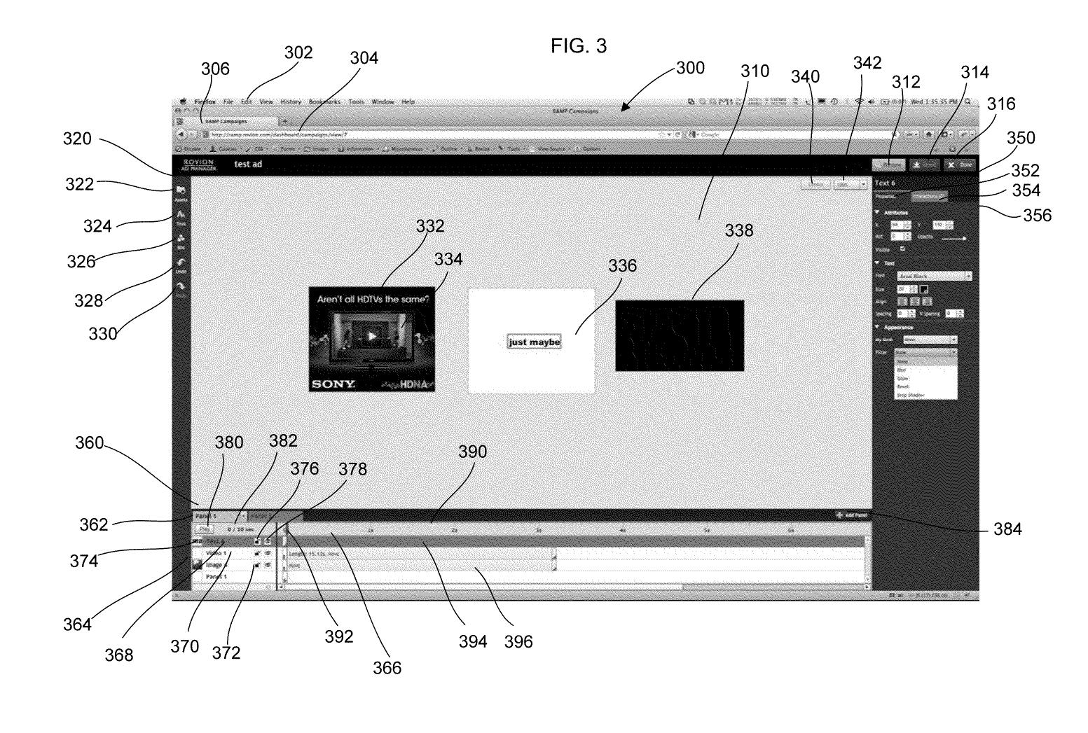

The interface 200 also has a campaign ad summary window 220 that includes a listing of campaign ads that summarize each of the ads associated with the selected campaign. The summaries include the date of the ad, the elements in the ad, and the publishers of the ad. An element is a file object such as a graphic or a video that are parts of the ad. An options button 222 allows a user to get an ad, run a demonstration, edit tag information, or change access to a tag as will be explained below. A create ad button 224 allows access to the composer interface to edit an ad as explained below with reference to FIG. 3. An add element button 226 allows the creation of ads by adding elements as will be explained below with reference to FIG. 2D.

FIG. 2B is an image of a campaign summary interface that summarizes the campaigns loaded from a server such as the advertising content server 106. A summary window 230 shows a listing of all campaigns available within the account. A sort by field 232 allows the sorting of the listed campaigns by criteria such as by the newest, by campaign name, by client name, and by account name. The summary window 230 includes a general information field 234, a start column 236, an end column 238, a target column 240, and a delivered column 242. The general information field 234 includes the name of the campaign, the account associated with the campaign, and the client associated with the campaign. The start and end columns 236 and 238 list the start and end dates set for the campaign. The target column 240 lists the number of views that are targeted for a particular campaign during the start and end date. The delivered column 242 shows the actual number of views of the particular campaign. A create new campaign button 244 allows the user to create a new campaign.

FIG. 2C shows a window 250 that is displayed on the summary interface in FIG. 2B when the create new campaign button 244 is selected in FIG. 2B. The window 250 includes a campaign name entry field 252, a client menu 254, an add client button 256, a note entry field 258, an impressions target field 260, a start date entry field 262, an end date entry field 264, and a save button 266.

The name entry field 252 allows the entry of a name for the new campaign. The select client control 254 allows the user to select from a listing of current clients to associate with the new campaign. A new client may be added via the new client entry button 256. Notes relating to the new campaign may be added in the note entry field 258. The impression target entry field 260 allows entry of the number of views that is the target views for the ads in the campaign. The start date entry field and the end date entry fields 262 and 264 allow the entry of the dates of the campaign. The save button 266 allows the newly created campaign to be saved to the advertising server.

Once the ad campaign is created, the add element button 226 in FIG. 2A accesses an ad information entry window 270 shown in FIG. 2D on the interface 200. The window 270 includes a basic information tab 272 and an element settings tab 274. The basic information tab 272 displays entry fields including a new element name entry field 276, a click-through entry field 278, an ad type menu control 280, a width entry field 282, a height entry field 284, a size drop down menu 286, a composer ad button 288, an upload button 290, and an upload image button 292.

The ad name entry field 276 allows entry of the name of the newly created ad. The click-through entry field 278 allows the entry of the URL for the click-through to access to the ad. The ad type menu 280 allows the user to select between ad types such as an in-page non-expandable, an expandable, in person, and a footer ad type. Depending on the ad type selected via the ad type menu 280, the element settings tab 274 when selected displays different selectable options. An initial size setting of the ad is controlled by the entry of dimensions in the width field 282 and the height field 284. The size drop down menu 286 allows for the selection of predetermined width and height sizes for the ad. The compose ad button 288 allows the selection of the composer interface shown below in FIG. 3 for the user to design the ad. The upload ad button 290 allows the uploading of a completed ad from an accessible server. The upload back image button 292 allows the loading of a back-up graphic to be displayed if a user cannot access the ad from the content web page. A save elements button 294 allows the user to save the elements associated with the ad.

As explained above, the type of ad selected allows different options to be controlled when the element settings tab 274 is selected. If the ad type is an in-page non-expandable, the element settings include the composer click-throughs to designate links that access the ads and a z-index that allows control of the layering of the ad. If the ad type is an expandable ad, the element settings tab 274 includes entry fields for entry of click-through links. The element setting tab 274 also includes controls for expansion of the ad on the page, the time the ad transitions on the page, the initial location, control auto expand, and low and high z-index. A flash variable field also allows additional flash variables to be selected. If the ad type is an in person ad, the ad is interposed over the page in the form of a graphic of a person, which may be animated. For in person ads, the initial location of the ad may be selected via the element setting tab 274. Move left and right and move up and down controls allow a user to control where the graphic of the person moves on the linking content web page as well as a z-index. If the ad type is a footer ad, a background bar, opacity, and height of the ad are selectable via the element setting tab 274.

FIG. 3 is a screen view of a browser based composer interface 300 that may be accessed via the compose button 288 of the management interface 200 in FIG. 2D. The composer interface 300 allows a user to produce multi-media tags or content such as advertising content that may be inserted in content web pages. The browser based composer interface 300 in this example is run on the workstation 112 in FIG. 1, but any web browser capable computing device may run the composer interface 300 to allow a user to produce advertising tags for content web pages or other content that may be accessed via tag code from another web page as described above.

The composer interface 300 includes a standard menu bar 302 and a URL field 304 that accesses tab files that may be stored in an advertising content server such as the advertising content server 106 in FIG. 1 for access by the advertising server 104 or other workstations. The interface 300 includes a series of tabs such as a tab 306 that allows navigation over multiple web pages that may be opened. The interface 300 also includes a stage or workspace field 310 showing the components of the tab or content for a web page assembled by the user.

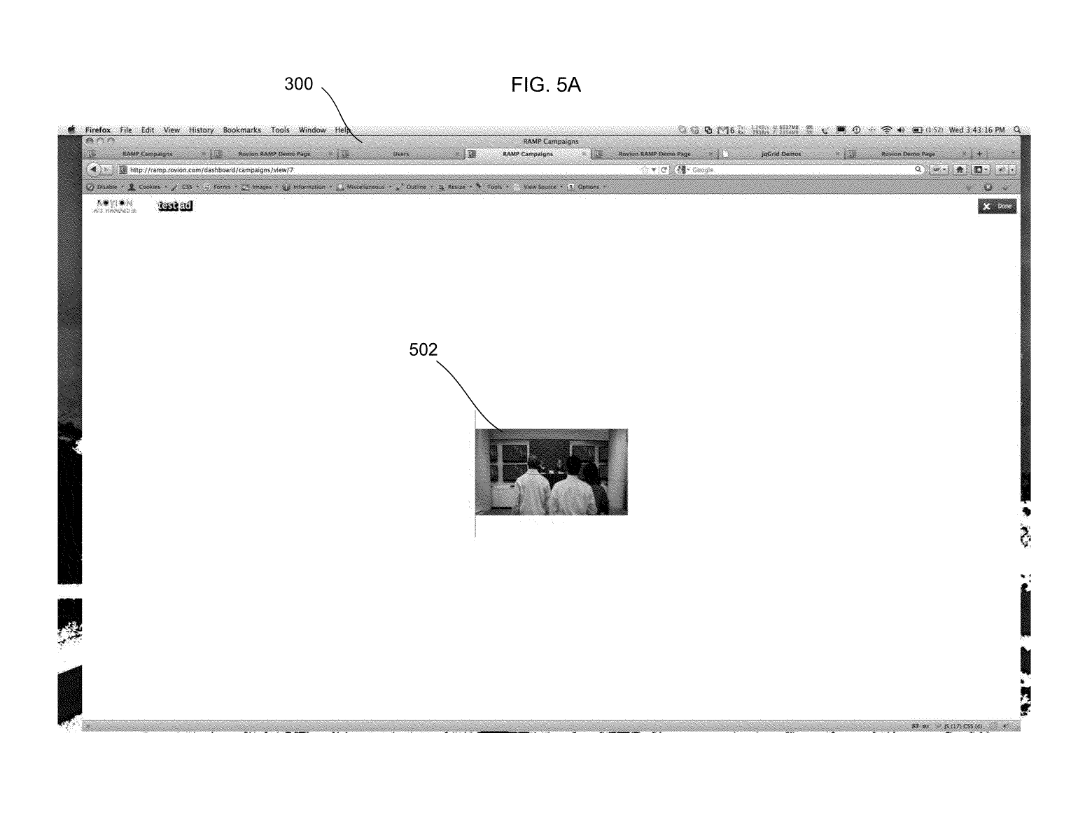

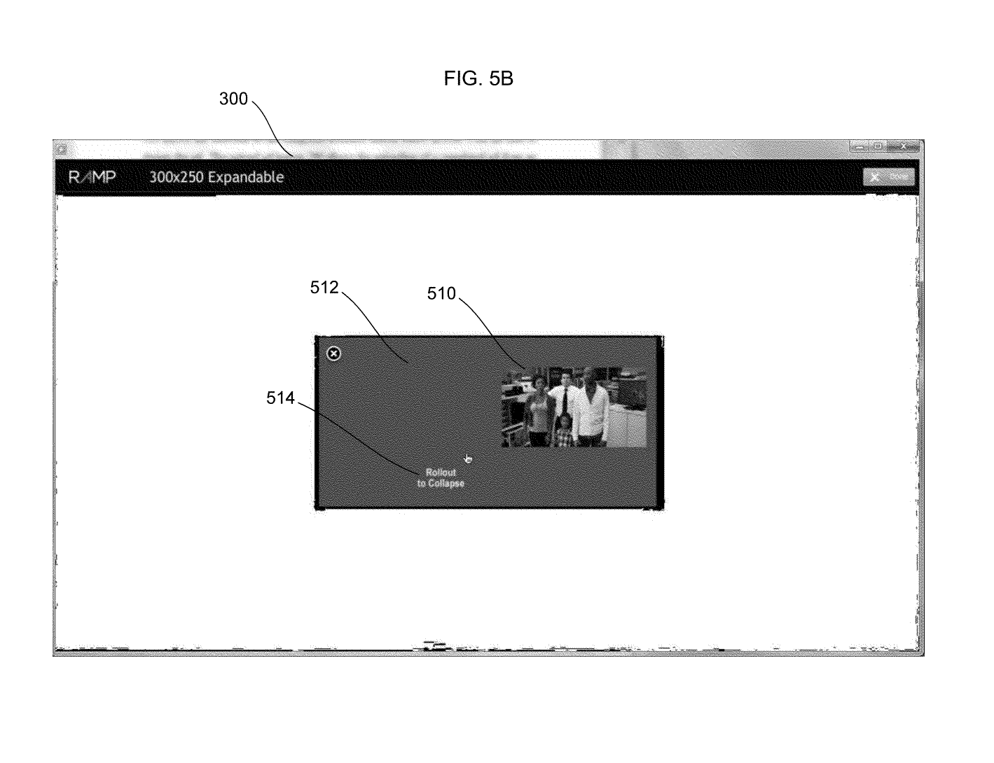

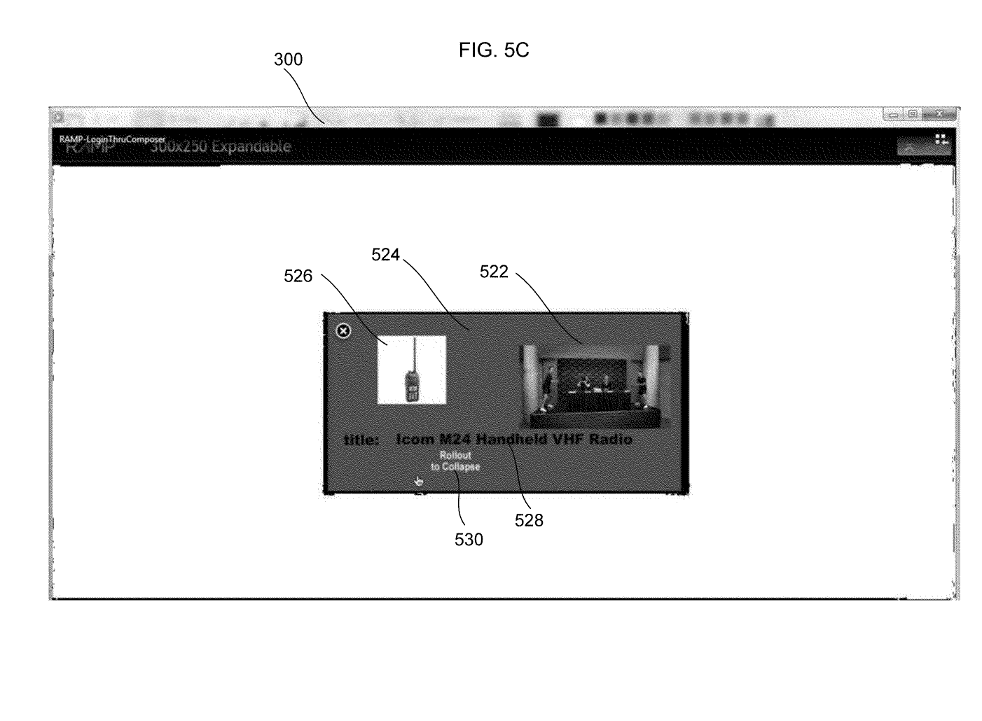

The composer interface 300 includes control buttons such as a preview button 312, a save button 314, and a done button 316. The preview button 312 allows the user to view the actual appearance of the ad that will be inserted in a web page. The actual appearance of the ad, which is determined by the objects inserted in the workspace field 310 by the user as explained below with reference to FIG. 5A. The save button 314 allows the user to save the ad or content to a destination such as the workstation 112 or a storage server such as the advertising content server 106 in FIG. 1. The done button 316 indicates that the tab or content is complete and will save the tab for loading on the advertising content server 106 in FIG. 1. Alternatively, there may be an auto save feature that may be installed in addition to or in place of the save button 314 that periodically saves the tab. There may be two types of saves creating two tab files. A first saved working version may be accessed for further editing of the tab prior to allowing access by a content web page. A second type of save may be made via the control interface 200 in FIG. 2A to publish the ad (not shown in FIG. 3) that converts the ad to a Flash file that may be accessed by a content web page via the tag. As will be explained, the publishing save loads the saved ad to the advertising content server 106 and allows access to script according to the engine on the advertising server 104 from publishers that control a content server such as the content web server 102. The publishing save may also update a global network of servers that serve the particular content that provides the tag to the content web page or pages to access the ad.

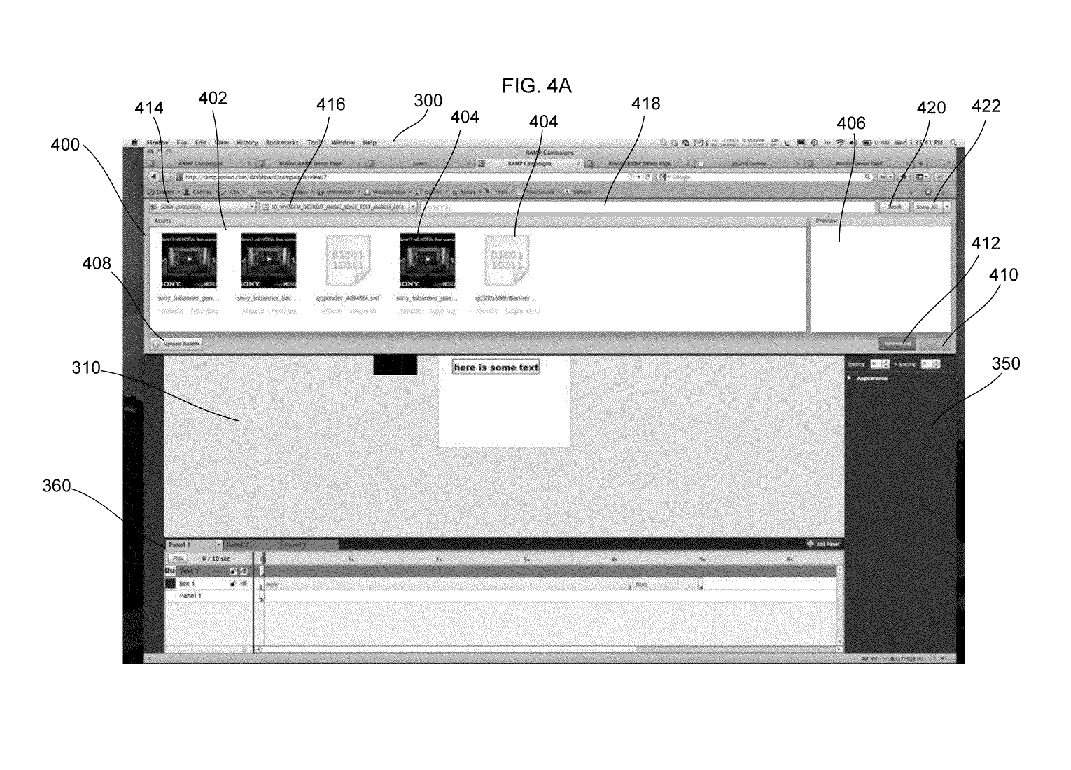

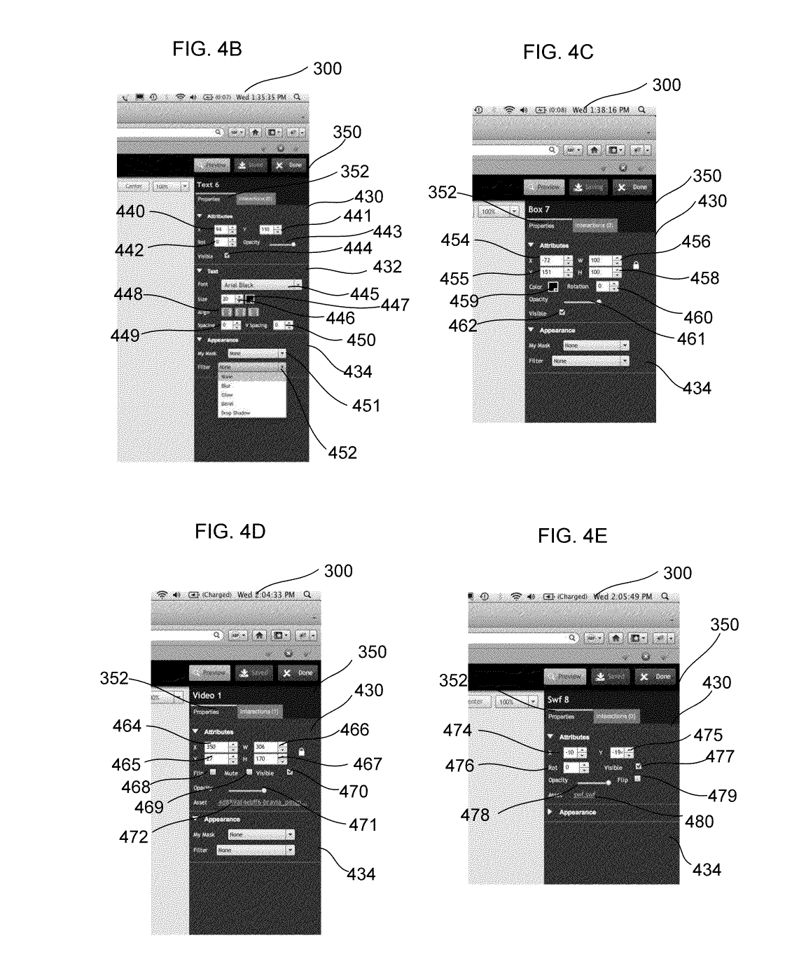

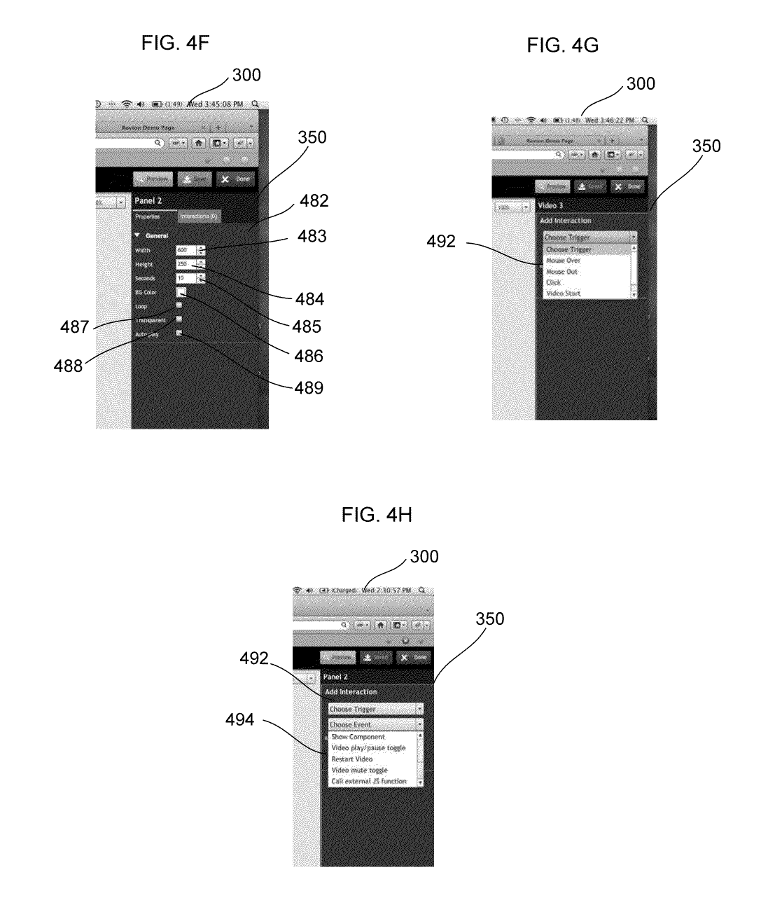

The interface 300 has a tool column 320 that includes an asset icon button 322, a text icon button 324, a drawing icon button 326, an undo icon button 328, and a redo icon button 330. The icons in the tool column 320 allow manipulations of objects in the workspace field 310. The asset icon button 322 allows the user to access different media content such as that stored on the workstation 112 or a media content server such as the media content server 110 or the content server 126 in FIG. 1. Selection of the assets icon button results in a pop window to access objects as will be explained below with reference to FIG. 4A. The text icon button 324 allows a user to place text in the workspace field 310. The drawing icon button 326 allows a user to place a drawing shape such as a box in the workspace field 310. The undo icon 328 and the redo icon 330 allow the user to undo or redo previous actions.

In this example, a number of objects have been placed in the workspace field 310. The objects are selected via the object icons in the tool column 320. These object icons include an image object 332, a video object 334 (accessed from the asset icon button 322), a text object 336, and a drawing object 338. As will be explained below, other objects such as animations or audio clips may be placed in the workspace field 310. The workspace field 310 may be manipulated according to a center button 340 that centers the workspace field 310 and a size button 342 to zoom in or zoom out on particular parts of the workspace field 310.

The interface 300 includes an object control window 350 that includes various tools to control the appearance of objects in the workspace field 310. The object control window 350 includes a properties tab 352 and an interactions tab 354. The properties tab 352 allows a user to adjust the properties of a selected object in the workspace field 310. The properties tab 352 has been selected in FIG. 3 for a selected text object such as the text object 336. The interactions tab 354 allows a user to control how the object interacts with other objects in the script and a timeline for the web page. Each type of object has associated controls in the properties tab 352 and the interactions tab 354 as will be explained below with reference to FIGS. 4B-4E.

The bottom of the interface 300 includes a panel field 360 which allows a user to script out the interactions and appearance of each object in the ad. The panel field 360 includes a series of panel tabs 362, which allow a user to manipulate each panel in the script for the tab or content inserted in a web page. Selecting a panel tab 362 displays an objects window 364 and a timeline 366 that represent the objects present in the panel and the time period associated with the panel. Thus, selecting a panel tab 362 allows the adding of objects shown in the workspace field 310 during a certain time period represented by the panel of the tab or content.

The objects window 364 includes a field for each object in the panel such as a text field 368, a video field 370, and an image field 372. Each of the object fields such as fields 368, 370, and 372 includes the respective names of the objects and track the objects appearing in the panel. Of course additional objects may be represented by additional fields if additional objects are inserted in the workspace field 310 for the panel. Each of the object fields in the object window, such as the text field 368, include a thumbnail area 374, a lock icon 376, and a viewable icon 378. The thumbnail area 374 is a thumbnail view of the object. The lock icon 376 indicates whether the object is locked or fixed in the workspace field 310 for the duration of the panel. The viewable icon 378 indicates whether the object is viewable or hidden in the panel.

The properties of the panel may be changed via the object control window 350 as shown in FIG. 4F. The panel field 360 includes a play button 380 that when selected allows the panel to be viewed over the timeline 366. The panel field 360 also includes a time indicator 382 that indicates the current time of the panel. An add panel button 384 allows a user to add another panel to the panel field 360. The timeline 366 includes a horizontal time scale 390 that is scaled for the time the panel is active. In this example, the first panel selected by the panel tab 362 is ten seconds long, and the time scale 390 indicates ten one-second increments. The panel may be viewed along the time line by moving a slider 392 along the time scale 390. A single object may be selected and therefore a bar 394 is shaded. The bar 394 associated with each object such as the text object in FIG. 3 displays timeline movements, transitions, and interactions of the object. Other bars such as the bar 296 include information specific to other types of objects such as a video object.

FIG. 4A is a screen image of the composer interface 300 when a user selects the asset icon 322 in the composer interface 300 in FIG. 3. In response, the composer interface 300 opens an asset selection window 400 that includes a media content selection field 402. The media content selection field 402 includes a series of icons 404 that represent assets or media content, a preview field 406, and an upload assets button 408. Each of the icons 404 represent media content files such as an image file in an image format such as jpeg, an audio file in an audio format such as MP3, a video clip in a video format such as MPEG, or an animation file in an animation format such as Flash (.swf) that may be uploaded to be inserted in the workspace field 310. The preview field 406 allows the user to view the media content objects that are selected from the media content selection field 402. The upload assets button 408, when selected, uploads a selected media content file from any storage device accessible from the computing device running the composer interface 300 to the media content selection field 402 in FIG. 4A. Thus, media content files stored on the device such as the workstation 112 in FIG. 1 or other accessible devices such as the media content server 110 in FIG. 1 or other media content storage may be used to generate the tag. The icons 404 may be selected and dragged on the workspace field 310 or by activating a select button 410, which allows a user to drop it to the workspace field 310. A cancel button 412 will exit from the asset selection window 400.

Various media content files may be accessed by navigation controls including a client dropdown menu 414, a campaign dropdown menu 416 and a search field 418. The client dropdown menu 414 lists the different clients while the campaign dropdown menu 416 lists the different campaigns associated with the selected client from the client dropdown menu 414. Once a campaign and client is selected via the menus 414 and 416, all media content associated with the campaign is displayed via the icons 404 in the media content selection field 402. A user may use the search field 418 to search for specific media content by name. A reset button 420 resets the search. The search may be refined for specific types of media content via a content type selection dropdown menu 422. A user may therefore only show image files, video files, animation files, etc. via a selection from the content type menu 422.

FIG. 4B is a screen view of the object control window 350 of the interface 300 when a text object has been selected on the workspace field 310. The object control window 350 allows a user to adjust the properties of a text object in the workspace field 310 using the controls detailed in FIG. 4B. The properties of the selected text object may be adjusted via settings in an attributes field 430, a text appearance field 432, and an appearance field 434. The attributes field 430 allows a user to adjust the position of the text object in the workspace field 310 using x and y controls 440 and 441. The object may be rotated using a rotation field 442 that may rotate the text object by an input number of degrees. An opacity control 443 allows the user to adjust the opacity of the text object. A visibility check box 444 allows the user to control whether the text object is visible in the workspace field 310.

The text appearance field 432 includes a font selection field 445, a font size field 446, a color selection pull down menu 447, and an alignment menu 448. A horizontal spacing field 449 allows a user to adjust the space between text characters and a vertical spacing field 450 allows a user to adjust space between lines of text characters of the text object.

The appearance field 434 includes a masking pull down menu 451 and a filter pull down menu 452. The user may use the menus 451 and 452 to apply various photographic effects to the text object thereby eliminating the need for specialized touch up software for image objects prior to inserting the object in the workspace field 310.

FIG. 4C is a screen image of the composer interface 300 that shows the object control window 350 when a drawing object in the workspace field 310 is selected. As in FIG. 4B, the properties tab 352 is selected and includes the attributes field 430 and an appearance field 432 that includes the same options as those in FIG. 4B. The attributes field 430 is specific to a drawing object and includes an x position field 454 and a y position field 455 that control the position of the drawing object in the tab area. A width field 456 and a height field 458 allow a user to control the size of the drawing object. A color pull down menu 459 allows a user to select the fill color of the drawing object. A rotation field 460 allows the user to control the rotation of the drawing object in the workspace field 310. The attributes field 430 also includes an opacity slider 461 to adjust the opacity of the drawing object and a visibility check box 462 to indicate whether the drawing object is visible within the final webpage.

FIG. 4D is a screen image of the composer interface 300 that shows the object control window 350 when a video object in the workspace field 310 is selected. As explained above, the video object is an asset that is either linked or loaded from a media content source. As in FIG. 4B, the properties tab 352 is selected and includes the attributes field 430 and an appearance field 432 that includes the same options as those in FIG. 4B. The attributes field 430 is specific to a video object and includes an x position field 464 and a y position field 465 that control the position of the video object in the area of the tab in the workspace field 310. A width field 466 and a height field 467 allow a user to control the size of the video object. A flip check box 468 allows a user to flip the video object to a different orientation. A mute check box 469 allows a user to mute any audio from the video object. The attributes field 430 also includes a visibility check box 470 to indicate whether the video object is visible within the final tab and an opacity slider 471 to adjust the opacity of the drawing object. An asset name field 472 includes the name of the video object that is selected.

FIG. 4E is a screen image of the composer interface 300 that shows the object control window 350 when an animation object in the workspace field 310 is selected. As explained above, the animation object is an asset such as a Flash file that is either linked or loaded from a media content source. As in FIG. 4B, the properties tab 352 is selected and includes the attributes field 430 and an appearance field 432 that includes the same options as those in FIG. 4B. The attributes field 430 is specific to an animation object and includes an x position field 474 and a y position field 475 that control the position of the drawing object in the area of the tab. A rotation field 476 allows the user to control the rotation of the animation object in the workspace field 310. The attributes field 430 also includes a visibility check box 477 to indicate whether the animation object is visible within the final tab and an opacity slider 478 to adjust the opacity of the drawing object. A flip check box 479 allows a user to change the orientation of the drawing object. An asset name field 480 includes the name of the animation object that is selected. Other specific applications may be accessed via the properties tab 352. For example, one application may adjust the price or brand name of a product that may be displayed in the ad according to data accessed from a database.

FIG. 4F is a screen image of the composer interface 300 that shows the object control window 350 when a panel from the panel field 360 in FIG. 3 is selected. The object control window 350 has a general properties field 482 for the panel that includes a width field 483 and a height field 484 that control the size of the panel on the web page. A time field 485 allows a user to select the length of time the panel is activated for the tab. A background color menu 486 allows a user to select the background color of the panel. A loop checkbox 487 allows a user to select whether or not the object interactions in the panel continue to loop back and replay. A transparent checkbox 488 allows a user to select whether the panel is transparent allowing the underlying web page to be visible. An autoplay checkbox 489 allows a user to select whether the panel interactions are automatically played when the panel is displayed.

FIGS. 4G-H are screen views of the object control window 350 when the interactions tab 354 is selected. The interactions tab 354 includes a trigger pull down menu 492 shown in FIG. 4G and an event pull down menu 494 shown in FIG. 4H. The menus 492 and 494 allow a user to select the triggering of dynamic action of the selected object. The triggers are actions that will begin the action and may include a mouse over, a mouse out, a click on the object or a video starting. The events are the actions that are triggered and may include showing the component or object, playing the video, pausing the video, restarting the video, muting or unmuting the video, calling an external javascript function, switching panels, changing page URL, play/pause panel animation, restart panel animation, or seek to a point in the timeline.

FIGS. 5A-5C are different screen views of a display on a workstation such as the workstation 112 when the preview button 312 in the composer interface 300 in FIG. 3 is selected. The preview button 312 allows a user to see the appearance of the object or objects or a web page and tag on the panels that are being composed. The appearance of the panel may be stepped through to show each of the panels in the tag. FIG. 5A shows the interface 300 when the preview button 312 in FIG. 3 is selected. FIG. 5A shows an ad that has a panel with a single video object 502.

FIG. 5B shows a more complex panel that includes a video object 512, a background box 514 and a text object 516. In the example shown in FIG. 5B, the panel is activated by an initial panel (not shown). The video object 502 is triggered to be played if a mouse cursor is passed over the text object 516.

FIG. 5C shows another example of the display of a panel for a tag that is the result of selecting the preview button 312 in FIG. 3. FIG. 5C shows the preview of a tag that includes a video object 522, a background box 524, an image object 526, a text object 528, and another text object 530. In this example, the panel displayed is activated by the mouse over of an initial panel on the web page intended for the tag. The video object 522 is played when the panel is displayed. The text object 528 is the result of a specialized application where the description of the product shown in the image object 526 is automatically updated according to a database in each of the tags.

FIG. 6A is an image of the interface 200 in FIG. 2A after an ad has been created such as through the composer interface 300 in FIG. 3. Identical elements in FIG. 2A are labeled with like numbers in FIG. 6A. The ad summary window 220 now includes an ad icon 602, a settings button 604, a composer button 606, a publish button 608, and a share button 610.

The ad icon 602 represents a thumbnail of the ad. The settings button 604 allows a user to control the settings of the ad when presented by a web page. The composer button 606 allows a user to access the composer interface 300 in FIG. 3. The publish button 608 allows a user to send the completed ad to a server for access to linked pages. The share button 610 allows a user to share the ad with other users on the network.

In FIG. 6A, the options button 222 has been expanded to display a get tag button 612, a share button 614, an edit button 616, and a demo button 618. The get tag button 612 allows the user to designate the java script for the tag. The share button 614 allows the user to share the tag with other network users. The edit button 616 allows a user to edit the tag parameters. The demo button 618 allows the user to display a demonstration of the ad as will be explained below with reference to FIG. 6C.

FIG. 6B is an image of the interface 200 when the settings button 604 in FIG. 6A has been selected. The ad summary window 220 now includes an image quality field 622, a frame rate field 624 and a delay asset loading checkbox 626. The image quality field 622 allows compression of the ad by a designated percentage such as the 80% selected in FIG. 6B, which makes the ad file smaller rather than rescaling various objects in the ad. The frame rate field 624 allows a user to set the frame rate of the converted Flash file in the ad. The delay asset loading checkbox 626 allows a user to delay the loading of large files from other content storage until such objects are actually called by the ad file. A publish button 628 allows a user to complete the publishing process after selecting the settings for the ad. After the publishing of the completed ad, the ad is loaded into the advertising content server 106 in FIG. 1 for access by content web pages. In this example, the completed ad is in a Flash format for Flash capable devices. However, the completed ad may also be converted to an HTML5 export path which allows the display of the ad created from the composer interface 300 on non-Flash devices, such as Apple's iOS devices.

FIG. 6C is a screen image of a demonstration screen 630 resulting from the selection of the demo button 618 in the management interface 200 in FIG. 6A. The demo button 618 allows published ads to be shown as they appear on a published web page. The demonstration screen 630 includes a simulated web page 632. The simulated web page 632 includes a link in the code to call the tag file from an advertising content server such as the advertising content server 106 in FIG. 1. The produced ad file is shown in a window area of the simulated web page 632, which shows the appearance of the created ad 634 developed using the composer interface 300 in FIG. 3. The demonstration screen 630 includes a position pull down menu 636 that allows a user to position the ad 634 in different locations on the simulated web page 632. A frame pull down menu 638 allows a user to test the ad's behavior when delivered via an iframe (a sub page within a web page), including: no iframe; iframe with the same domain as the main page; iframe with a different domain from the main page but with access to an iframe busting HTML page on the main page domain (allows the code to “break out” to the main page); iframe with a different domain from the main page; and no access to an iframe busting HTML page on the main page domain (impossible to “break out” to the main page).

FIG. 6D is a screen image of a report table 650 that is accessed by selecting the reports button 206 in the interface 200 in FIG. 2A. The report table 650 allows a user to track data for published ads in campaigns as will be explained below. Referring again to FIG. 1, an example analytics module running on an advertising server may include functional components for capturing and recording data items and system parameters that may be of use to the advertising agency or advertising content producers. The analytics recorded by the analytics module may include a variety of data, such as the number of users, numbers of domains acquired by users, categories of content most used by users, anonymized user profiles and demographics, site mappings, domain click through metrics, original content portal traffic, and the like. The analytics data can be stored in a database. This analytics data may be of use to a content provider such as one associated with the content server 102 for analysis of marketing and/or advertising activities.

The report table 650 includes a campaign selection drop down menu 652, a name entry field 654, a start date entry field 656, an end date entry field 658, and a hide entries field 660. The user may select various parameters to target reports. The campaign selection drop down menu 652 allows a user to run reports on a specific stored campaign. The name entry field 654 allows a user to enter a name of a campaign for running the report. The report may be limited by start and end date via entries in the start and end date entry fields 656 and 658. The user may also ignore different impressions or views under a certain number via entering a number under the hide entries field 660.

A parameter table 662 is provided to allow a user to select specific data to be displayed in the report. The parameter table 662 includes various listed general parameters 664 and check boxes 666 that allow a user to select such general parameters. For example, a user may select basic events, expansion events, visibility data, or video events. Each of the general parameters may be further refined by more detailed listed parameters such as a set of sub-parameters 668 under the basic events parameter. In this example, the sub-parameters include click-throughs and mouse-overs under the basic events parameter. A report 670 is shown based on the selected parameters and sub-parameters. The reports generated may be downloaded in a spreadsheet format via a download button 672.

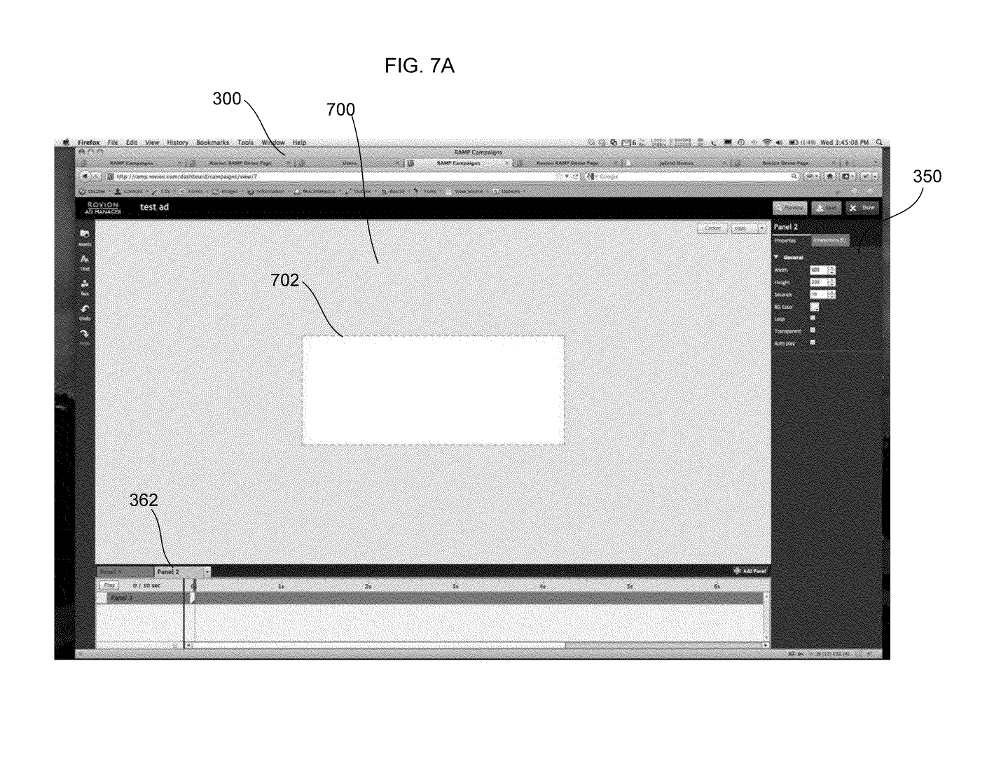

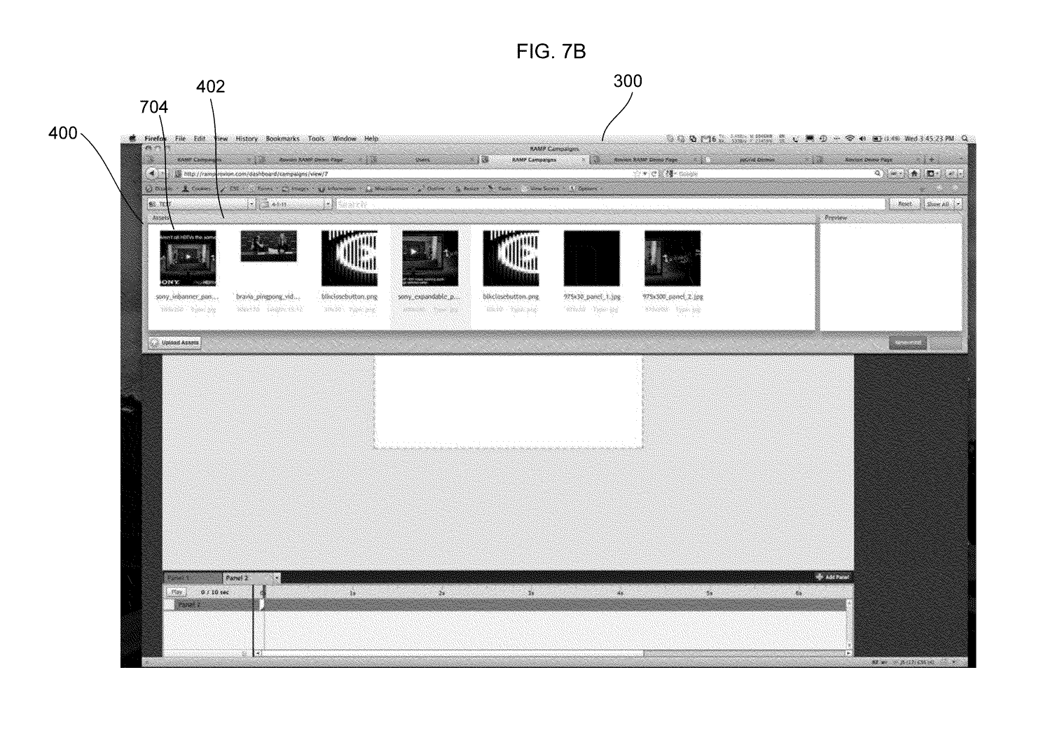

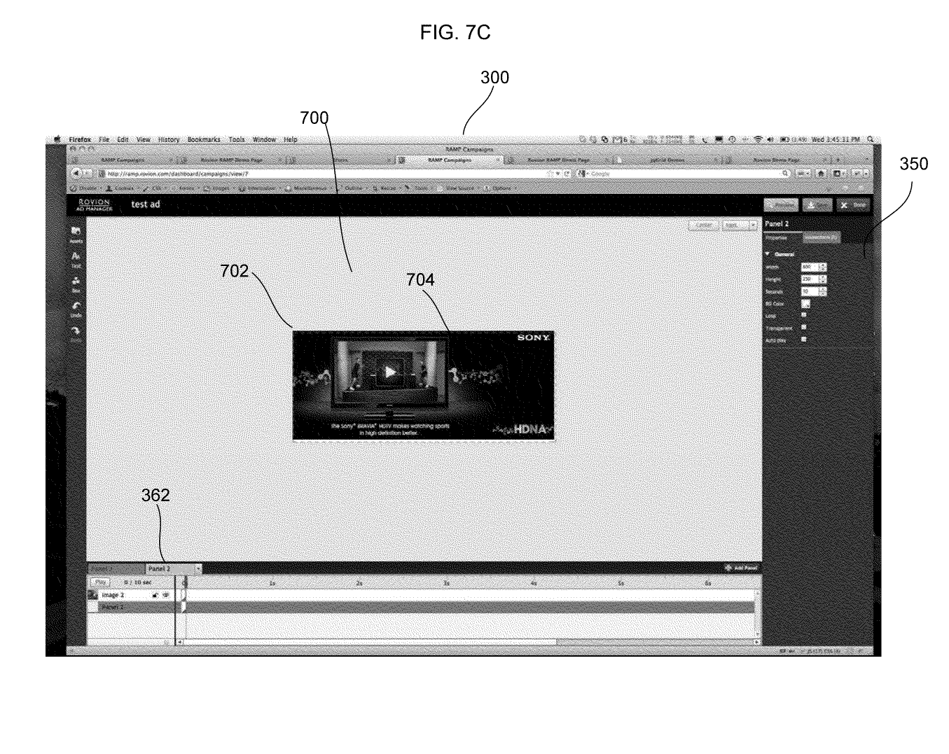

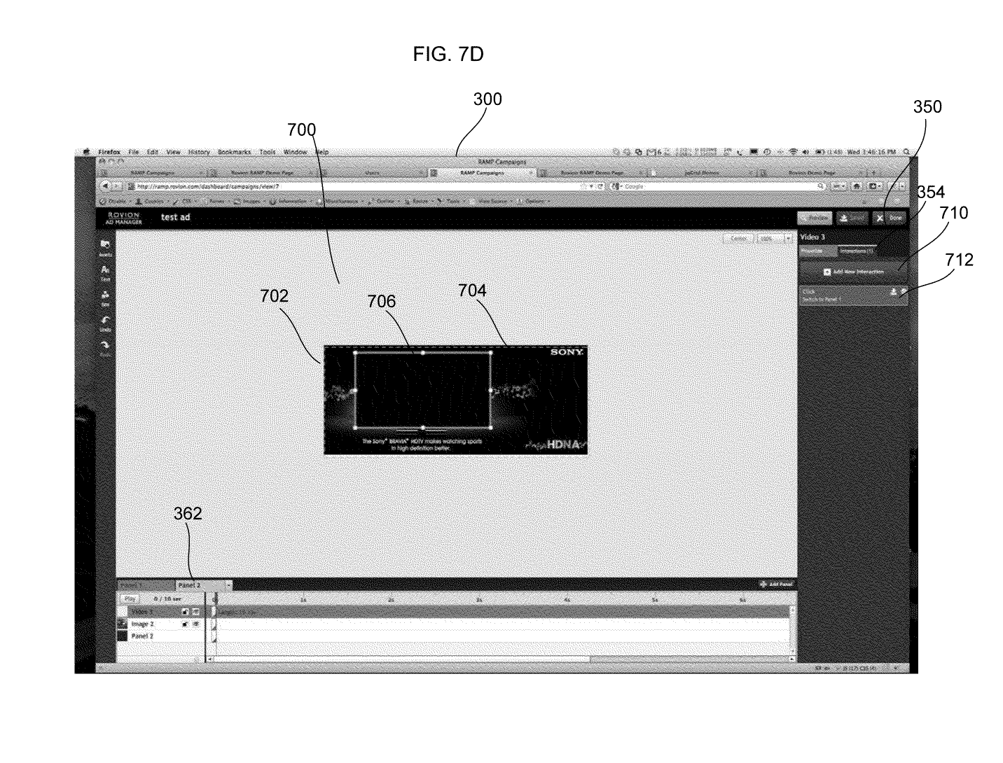

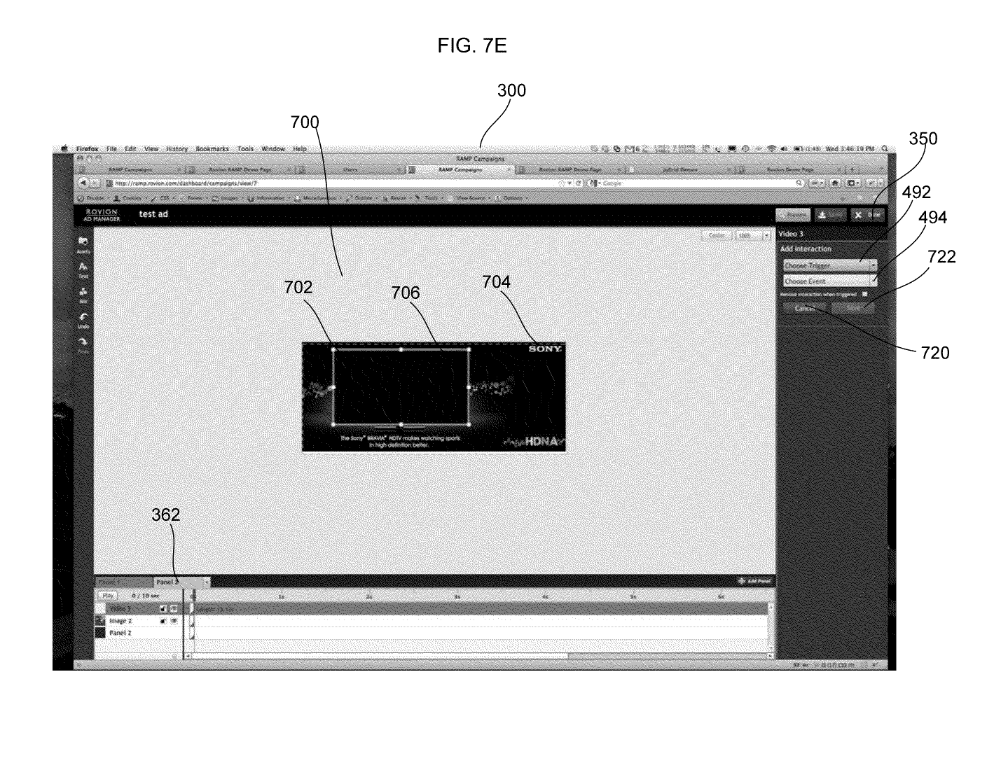

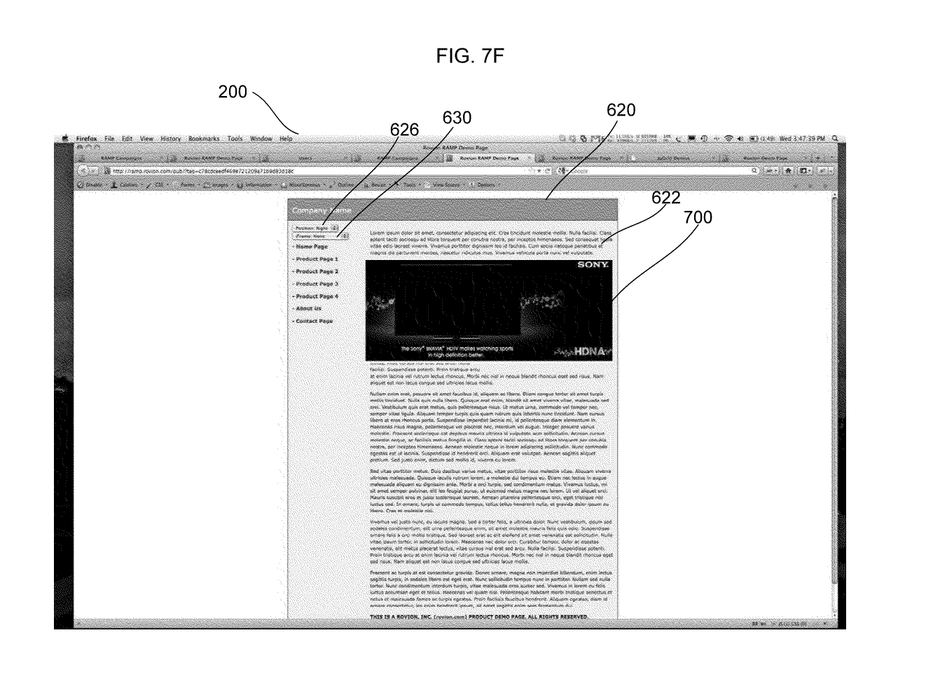

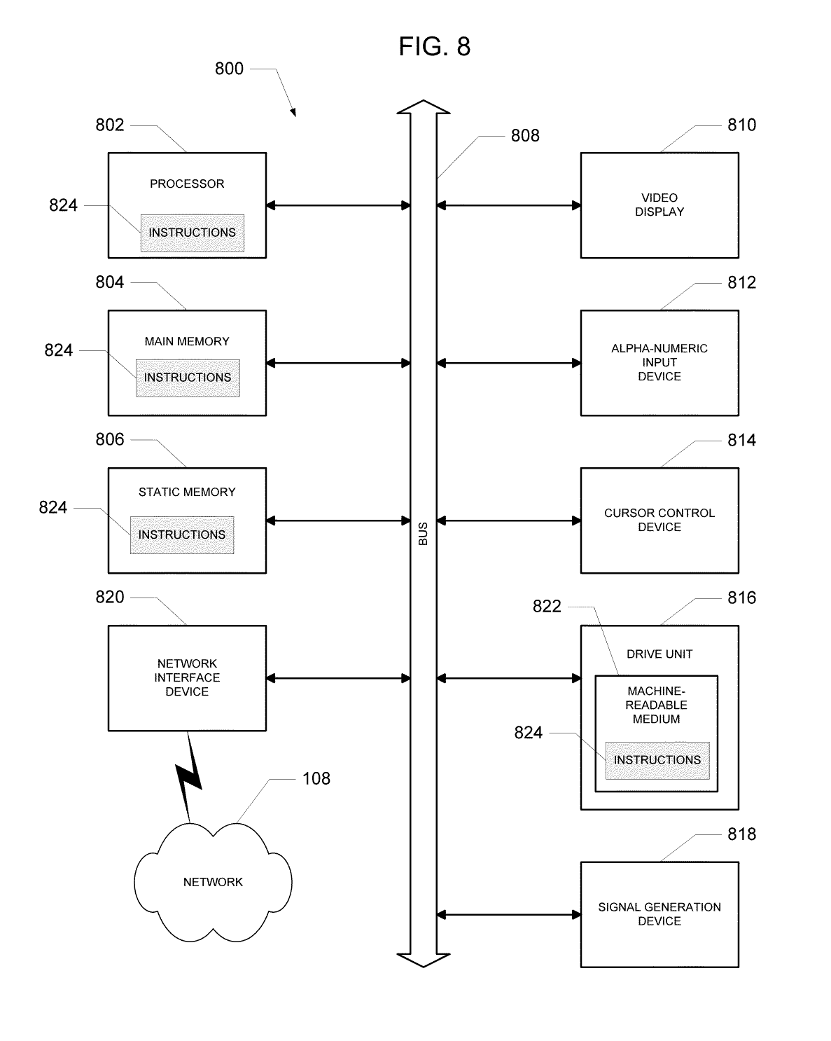

FIGS. 7A-7F are a series of screen views of the composer interface 300 in producing a tab for a content web page. FIG. 7A shows the composer interface 300 where a user is building a new tag 700. The user has selected a new panel 702 as shown in the panel tab 362. The user uses the controls in the object control window 350 of the composer interface 300 to set the size of the panel 702.

FIG. 7B shows the resulting display from selecting the asset icon 322 in the composer interface 300. The asset selection window 400 is displayed with an asset selection field 402 with icons 404 representing content files. One of the icons 704 represents an image file. A user will select the image file represented by the icon 704 to be placed in the panel 702.

FIG. 7C shows the resulting insertion of the image 704 in the panel 702. As shown in FIG. 7C, the panel tab 362 now includes an object field representing the inserted image 704. A user may use the asset selection window 400 in FIG. 7B to insert a video file as an object in the workspace field 310.

FIG. 7D shows the composer interface 300 when a video file object 706 has been inserted in the panel 702. As shown in FIG. 7D, the panel tab 362 now includes another object field representing the inserted video file object 706. The object control window 350 shows that the interactions tab 354 has been selected for a selected video object such as the inserted video file object 706. The object control window 350 now displays an add interaction button 710 and a switch panel button 712. The add interaction button 710 allows the user to add dynamic interactions to the tab 700. The switch panel button 712 allows a user to switch to other panels.

FIG. 7E shows the composer interface 300 when the video file object 706 has been selected. The object control window 350 now displays the trigger pull down menu 492 and an event pull down menu 494 to allow a user to specify the conditions to interact with the video. In this example, the event is the playing of the video file object 706 and the trigger is a mouse over the video object in the tab. As explained above, other events may be attached to other objects such as the image 704, such as expanding the image when the trigger is a mouse over.

FIG. 7F shows the result of selecting the demo button 618 in the management interface 200 in FIG. 6A. FIG. 7F shows the demonstration screen 620 where the ad 700 has been called from the simulated web page 632. The user may use the controls 626 and 630 to place the tag 700 in different areas of the simulated web page 632. The user may simulate the interactions by mousing over the objects displayed by the ad 700. In this example, the image 704 has been expanded over the simulated web page 632 and the video 706 starts playing in the demo mode shown in FIG. 7F.

An example computer system 800 may be used for any of the computing devices in FIG. 1 and includes a processor 802 (e.g., a central processing unit (CPU), a graphics processing unit (GPU), or both), a main memory 804, and a static memory 806, which communicate with each other via a bus 808. The computer system 800 may further include a video display unit 810 (e.g., a liquid crystal display (LCD) or a cathode ray tube (CRT)). The computer system 800 also includes an input device 812 (e.g., a keyboard), a cursor control device 814 (e.g., a mouse), a disk drive unit 816, a signal generation device 818 (e.g., a speaker), and a network interface device 820.

The disk drive unit 816 includes a machine-readable medium 822 on which is stored one or more sets of instructions (e.g., software 824) embodying any one or more of the methodologies or functions described herein. The instructions 824 may also reside, completely or at least partially, within the main memory 804, the static memory 806, and/or within the processor 802 during execution thereof by the computer system 800. The main memory 804 and the processor 802 also may constitute machine-readable media. The instructions 824 may further be transmitted or received over a network such as the networks 108 and 120 in FIG. 1 via the network interface device 820.

While the machine-readable medium is shown in an example to be a single medium, the term “machine-readable medium” should be taken to include a single medium or multiple media (e.g., a centralized or distributed database, and/or associated caches and servers) that store the one or more sets of instructions. The term “machine-readable medium” can also be taken to include any medium that is capable of storing, encoding, or carrying a set of instructions for execution by the machine and that cause the machine to perform any one or more of the methodologies of the various embodiments, or that is capable of storing, encoding, or carrying data structures utilized by or associated with such a set of instructions. The term “machine-readable medium” can accordingly be taken to include, but not be limited to, solid-state memories, optical media, and magnetic media.

A variety of different types of memory storage devices, such as a random access memory (RAM) or a read only memory (ROM) in the system or a floppy disk, hard disk, CD ROM, DVD ROM, or other computer readable medium that is read from and/or written to by a magnetic, optical, or other reading and/or writing system that is coupled to the processor, may be used for the memory.

Furthermore, each of the computing devices of the system 100 may be conveniently implemented using one or more general purpose computer systems, microprocessors, digital signal processors, micro-controllers, application specific integrated circuits (ASIC), programmable logic devices (PLD), field programmable logic devices (FPLD), field programmable gate arrays (FPGA), and the like, programmed according to the teachings as described and illustrated herein, as will be appreciated by those skilled in the computer, software, and networking arts.

In addition, two or more computing systems or devices may be substituted for any one of the computing systems in the system 100. Accordingly, principles and advantages of distributed processing, such as redundancy, replication, and the like, also can be implemented, as desired, to increase the robustness and performance of the devices and systems of the system 100. The system 100 may also be implemented on a computer system or systems that extend across any network environment using any suitable interface mechanisms and communications technologies including, for example telecommunications in any suitable form (e.g., voice, modem, and the like), Public Switched Telephone Network (PSTNs), Packet Data Networks (PDNs), the Internet, intranets, a combination thereof, and the like.

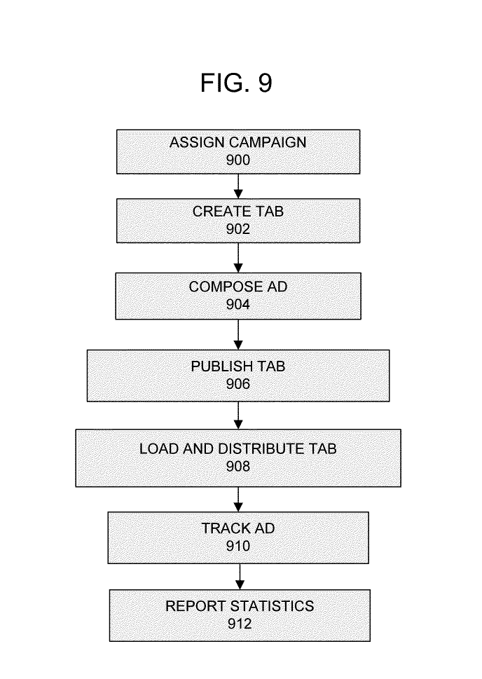

The operation of the example system 100 shown in FIG. 1, which may be controlled on the example workstation, will now be described with reference to FIG. 1 in conjunction with the flow diagram shown in FIG. 9. The flow diagram in FIG. 9 is representative of example machine readable instructions for implementing the interface to develop website with multi-media capability. In this example, the machine readable instructions comprise an algorithm for execution by: (a) a processor, (b) a controller, and/or (c) one or more other suitable processing device(s). The algorithm may be embodied in software stored on tangible media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or dedicated hardware in a well-known manner (e.g., it may be implemented by an application specific integrated circuit (ASIC), a programmable logic device (PLD), a field programmable logic device (FPLD), a field programmable gate array (FPGA), discrete logic, etc.). For example, any or all of the components of the interfaces could be implemented by software, hardware, and/or firmware. Also, some or all of the machine readable instructions represented by the flowchart of FIG. 9 may be implemented manually. Further, although the example algorithm is described with reference to the flowchart illustrated in FIG. 9, persons of ordinary skill in the art will readily appreciate that many other methods of implementing the example machine readable instructions may alternatively be used. For example, the order of execution of the blocks may be changed, and/or some of the blocks described may be changed, eliminated, or combined.

FIG. 9 is a flow diagram of the process of loading a created tab in a webpage. The initial parameters of the campaign and account are selected (900). The user then creates a tab using the composer interface 300 in FIG. 3 (902). The user then selects and arranges objects such as text, drawings, images, video, animation, audio, etc. in the ad (904). After the user has finished with the tab design, the user may publish the ad (906) thereby making the ad available for linking by content web pages.

After the ad is published, the ad is loaded into advertising content servers for distribution and access to content web pages via a tag (908). The completed ad is then tracked using the analytics module (910). A report is generated based on the tracking data (912).

Each of these embodiments and obvious variations thereof is contemplated as falling within the spirit and scope of the claimed invention, which is set forth in the following claims.

What is claimed is:

1. A method of creating interactive content to be linked via a tag to appear in a web page, the method comprising:
providing a first panel including a first object displayable on the web page via a composer interface, the first object having a first interaction when displayed on the web page;
providing a second panel including a second object via the composer interface, the second object being displayable on the webpage in place of the first panel;
creating a timeline via the composer interface to sequentially present the first and second panels in the web page;
making the tag available for in the web page for displaying the first and second panels when the web page is requested by a user device.

2. The method of claim 1, wherein the first object is one of text, an image, a video clip, an audio clip or an animation file.

3. The method of claim 1, wherein the first and second objects of the tab are related to an advertisement.

4. The method of claim 1, wherein each panel has a plurality of layers, each layer including an object for display in the web page.

5. The method of claim 1, wherein the tab includes scalability for different dimensions for the web page being requested from a plurality of user devices having different web browser enabled hardware.

6. The method of claim 1, wherein the composer interface is enabled on a web browser.

7. The method of claim 1, wherein the interaction of the first object is enabled by a specific action defined by a user.

8. The method of claim 1, wherein the first object includes appearance properties that are controlled by a user via the composer interface.

9. The method of claim 1, wherein the content is converted to a flash file for loading by the user device when requesting the web page.

10. A system for distributing advertising web based ads to content webpage providers, the system comprising:
a composer interface to provide an ad for display on a web page, the ad causing an sequential display of media objects based on at least a first panel and a second panel;
an advertising storage server storing the ad generated by the web based composer interface;
a tab that allows access to the advertising storage server for the ad, the tab being insertable in the web page.

11. The system of claim 10, wherein the media objects include one of text, an image, a video clip, an audio clip or an animation file.

12. The system of claim 10, wherein each panel has a plurality of layers, each layer including an object for display in the web page.

13. The system of claim 10, wherein the tab includes scalability for different dimensions for the web page being requested from a plurality of user devices having different web browser enabled hardware.

14. The system of claim 10, wherein the composer interface is enabled on a web browser.

15. The system of claim 10, wherein interaction of at least one media object is enabled by a specific action defined by a user.

16. The system of claim 10, wherein at least one media object includes appearance properties that are controlled by a user via the composer interface.

17. A browser based interface for creating content linked via a tag to a web page, the interface comprising:
a workspace field for placement of objects representing the content for linking from the web page;
a media content storage interface to allow selection of a media content object for the workspace field;
a panel control for displaying one of a plurality of panels in the workspace field, the panel control including a timeline control to sequence the appearance of objects in the panel; and
an object control menu for determining the appearance of at least one object placed in the workspace field.

18. The interface of claim 17, further comprising a publishing control that converts the content into a file for access by the web page.

19. The interface of claim 18, wherein the content is converted into a flash file.

20. The interface of claim 17, wherein the objects are one of text, an image, a video clip, an audio clip or an animation file.

21. The interface of claim 17, wherein the content is an advertisement.

22. The interface of claim 17, wherein the tag includes scalability of the content for different dimensions for the web page being requested from a plurality of user devices having different web browser enabled hardware.

23. The interface of claim 17, wherein an interaction of the object is enabled by a specific action defined by a user.
